(19) United States
(12) Patent Application Publication
(10) Pub. No.: US 2020/0039183 A1
(43) Pub. Date: Feb. 6, 2020

(54) Graphene Reinforced Glass

(71) Applicant: Jonah Song Han, Ashburn, VA (US)

(72) Inventor: Jonah Song Han, Ashburn, VA (US)

(21) Appl. No.: 16/522,480

(22) Filed: Jul. 25, 2019

Related U.S. Application Data
(60) Provisional application No. 62/713,458, filed on Aug. 1, 2018.

(51) Int. Cl. B32B 9/00; B32B 17/06; B32B 17/10; B32B 27/36

(52) U.S. Cl. CPC B32B 9/007; B32B 17/06; B32B 2307/558; B32B 27/365; B32B 17/10752

(57) ABSTRACT

A reinforced glass composite screen which is relatively lightweight and provides relatively high strength and visibility. The glass composite is comprised of alternating layers of tempered glass, graphene, and/or plastics with an optional laminated layer of plastic in the case of directional specific impact to prevent shattering.

### FIELD OF THE INVENTION

The present invention relates to a reinforced glass pane having a plurality of layers of glass, graphene and/or plastics connected two-dimensionally to form a composite.

### DESCRIPTION OF THE PRIOR ART

The current status of the art involves various multilayered-combinations of materials to obtain reinforced glasses.

Common materials include (but are not limited to):

a) Polyvinyl butyral films
b) Polyurethane films
c) Ethylene-vinyl acetate

### d) Crystallizable PET

e) Spinel ceramics
f) Tempered glass

The number of layers is not relevant, and directly scales to the intended strength of a reinforced glass pane.

In accordance with what has been analyzed above, here follow some antecedents for information purposes.
a) U.S. Pat. No. 10,093,079 to Alberto Oscar Fontela entitled “REINFORCED SAFETY GLASS AND METHOD OF MANUFACTURE”, granted on Oct. 9, 2018. It consists of a multilayered reinforced glass pane using polymers and plastics (PU and CPET) to increase the resistance of a glass pane. It also describes the manufacturing process for such a structure.
b) U.S. Pat. No. 5,445,890 to Charles E. Bayha et al. entitled “BULLET RESISTANT GLASS/GLASS, GLASS/PLASTIC, AND PLASTIC/PLASTIC LAMINATE COMPOSITES”, granted on Aug. 29, 1995. It consists of ballistic resistant glass comprised of glass and plastic sheets bonded adhesively with a novel resin. The invention also relates to a vertical liquid pour process for quick manufacturing of bullet resistant glass panes without the use of traditional ovens or high heat environments.
c) U.S. Pat. No. 4,594,290 to William F. Fischer et al. entitled “IMPACT RESISTANT LAMINATE”, granted on Jun. 10, 1986. It consists of an impact resistant laminate of polyurethane and other polymer combinations.
d) U.S. Pat. No. 6,280,826 to Herwig Woll et al. entitled “BULLETPROOF GLASS WINDOW FOR A MOTOR VEHICLE”, granted on Aug. 28, 2001. It consists of a bulletproof glass window to be used in a framing or chassis of a vehicle window. The structure is comprised of a number of glass planes and polyurethane layers. The invention has an intended impact side, and an interior side coating to prevent inward shattering.

### BACKGROUND OF THE INVENTION

Currently, standard single-pane glass is used in the majority of the world's windows, vehicle windshields, and glass doors. This type of glass is easily shattered, creating many sharp edges which can cause serious injury or death. Furthermore, this glass provides little to no protection against intruders or outside forces. Vehicle windshields are brittle and occupants are often launched through them when the vehicle comes to an abrupt stop, leading to serious injury or death.

Traditional reinforced glass is made of layers of glass, plastics, and/or ceramics bonded together to form a composite. The glass layers can shatter when sufficient force is applied, while the interlayers of plastics and/or ceramics act to absorb and distribute the force. Thus, the reinforced glass can withstand much greater forces and retain its structural integrity. Some reinforced glass claim to be “bulletproof”. However, the glass is not actually bulletproof as no material can be entirely bulletproof. Rather, this glass is bullet resistant and requires very thick layers in order to stop even a lower caliber bullet. Both reinforced and bulletproof glass are thick and bulky and can be shattered relatively easily.

Graphene is a single atomic layer of carbon atoms arranged in a two-dimensional hexagonal configuration. Graphene is the strongest material discovered to date and has incredible tensile strength and flexibility. However, it only adopts these characteristics when it is in a single atomic layer. By using single atomic layers of graphene in addition to, or instead of, current plastic layers, the reinforced glass would have a tremendous increase in strength and bulletproof capabilities, while remaining lightweight, thin, and optically clear.

### BRIEF SUMMARY OF THE INVENTION

The present invention provides reinforced glass which uses a plurality of layers of glass, graphene, and/or plastics bonded to form a composite in order to absorb and distribute impact force among the entire surface. The physical properties of graphene allow the glass composite to absorb extreme amounts of force and potentially stop oncoming objects, such as bullets or other projectiles. This glass composite is relatively thin and lightweight which allows it to be used in all fields where glass panes are used.

Graphene-reinforced glass can be an effective replacement for standard glass panes and can be used in multiple applications, such as in residential, commercial, and automotive industries.

### BRIEF DESCRIPTION OF THE DRAWINGS

FIG. 1 is a lateral view of a schematic representation of the basic structure of a graphene-reinforced glass device as embodiment 1 of the present invention.

FIG. 2 is a lateral view of a schematic representation of the basic structure of a graphene-reinforced glass device as embodiment 2 of the present invention.

FIG. 3 is a lateral view of a schematic representation of the basic structure of a graphene-reinforced glass device as embodiment 3 of the present invention.

FIG. 4 is a lateral view of a schematic representation of the basic structure of a graphene-reinforced glass device as embodiment 4 of the present invention.

### DETAILED DESCRIPTION OF THE PREFERRED EMBODIMENTS

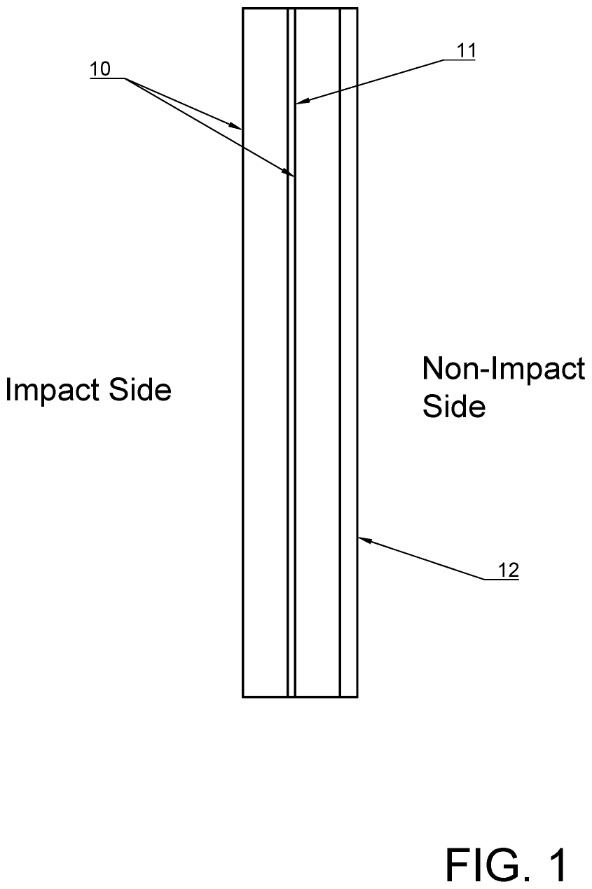

FIGS. 1 to 4 are sectional views illustrating the general structures of the preferred embodiments and are not drawn to scale or specific to certain dimensions.

FIG. 1 shows a graphene-reinforced glass device according to embodiment 1. FIG. 1 consists of a layer of graphene 11 sandwiched between two layers of glass 10. A shatterproof layer of polycarbonate laminate 12 is applied to the non-impact side. The glass 10, graphene 11, and the polycarbonate laminate 12 are all bonded under high amounts of heat and pressure to form a composite and thus increase the amount of force a reinforced glass pane can withstand before shattering.

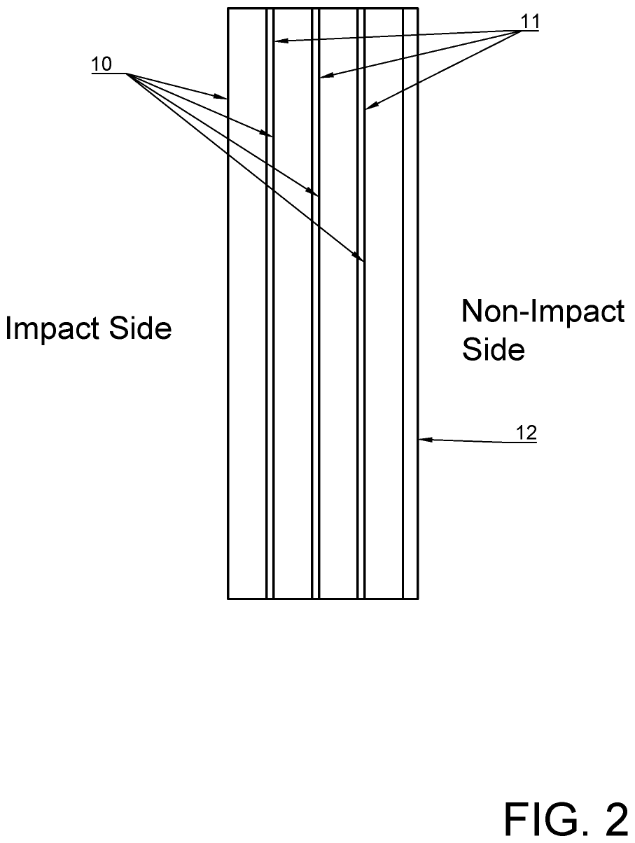

FIG. 2 shows a graphene-reinforced glass device according to embodiment 2. FIG. 2 consists of alternating layers of glass 10 and graphene 11 with a polycarbonate laminate 12 on the non-impact side. All layers are bonded under high amounts of heat and pressure to form a composite and thus increase the amount of force a reinforced glass pane can withstand before shattering.

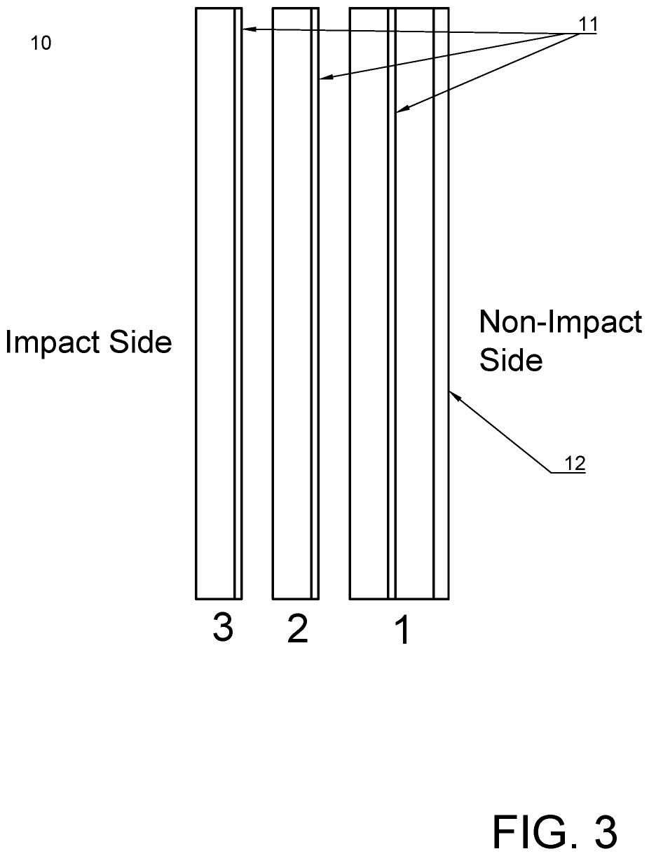

FIG. 3 shows a graphene-reinforced glass device according to embodiment 3. FIG. 3 consists of the embodiment described in FIG. 1 with further levels of protection 2, 3 visualized but not bonded. The levels of protection 2, 3 can be bonded under high amounts of heat and pressure to form a composite and thus increase the amount of force a reinforced glass pane can withstand before shattering.

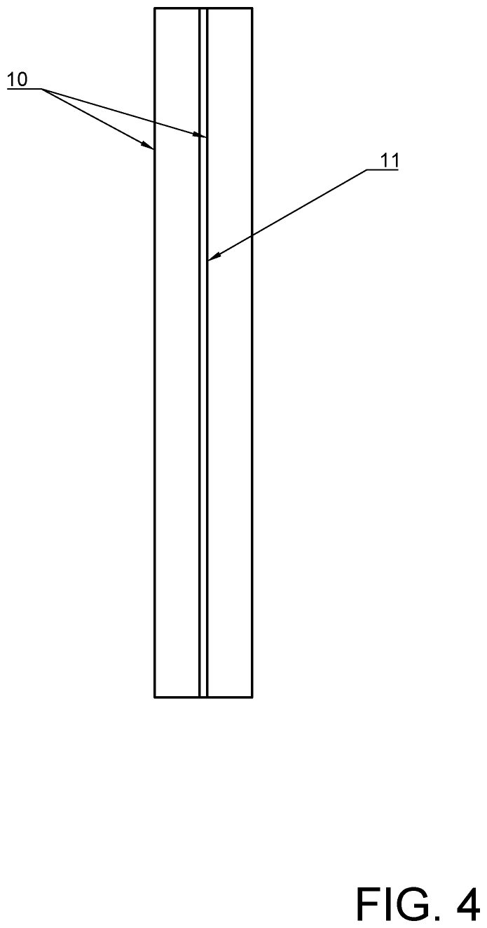

FIG. 4 shows a graphene-reinforced glass device according to embodiment 4. FIG. 4 consists of a layer of graphene 11 sandwiched between two layers of glass 10. However, the figure has no front face or impact side and can receive force from either side while still maintaining structural integrity. These layers are bonded under high amounts of heat and pressure to form a composite and thus increase the amount of force a reinforced glass pane can withstand.

The embodiments of the invention in which an exclusive property or privilege is claimed are defined as follows:

1) A reinforced glass screen, comprising:
a plurality of glass panes separated by layers of graphene and bonded to each other.

2) A reinforced glass screen, comprising:
a plurality of glass panes separated and bonded by layers of graphene and polyester resin films.

3) A reinforced glass screen, comprising:
a plurality of glass panes separated and bonded by layers of graphene and polycarbonate resin films.

4) The reinforced glass screen as defined in claim 1, with two, three, four, five, or six layers of glass and graphene.

5) The reinforced glass screen as defined in claim 2, with two, three, four, five, or six layers of glass, polyester resin films, and graphene.

6) The reinforced glass screen as defined in claim 3, with two, three, four, five, or six layers of glass, polycarbonate resin films, and graphene.

7) The reinforced glass screen as defined in claim 1, with a shatter-resistant plastic laminate on the side opposite the intended impact surface.

8) The reinforced glass screen as defined in claim 2, with a shatter-resistant plastic laminate on the side opposite the intended impact surface.

9) The reinforced glass screen as defined in claim 3, with a shatter-resistant plastic laminate on the side opposite the intended impact surface.

10) The reinforced glass screen as defined in claim 4, with a shatter-resistant plastic laminate on the side opposite the intended impact surface.

11) The reinforced glass screen as defined in claim 5, with a shatter-resistant plastic laminate on the side opposite the intended impact surface.

12) The reinforced glass screen as defined in claim 6, with a shatter-resistant plastic laminate on the side opposite the intended impact surface.
